(19) United States
(12) Patent Application Publication
(10) Pub. No.: US 2018/0360131 A1
(43) Pub. Date: Dec. 20, 2018

(54) CHILD GARMENT

(71) Applicant: Rachel Wade, New York, NY (US)

(72) Inventor: Rachel Wade, New York, NY (US)

(21) Appl. No.: 16/005,283

(22) Filed: Jun. 11, 2018

Related U.S. Application Data
(60) Provisional application No. 62/519,571, filed on Jun. 14, 2017.

(51) Int. Cl. A41B 13/10; A41D 11/00; B32B 5/02

(52) U.S. Cl. CPC A41B 13/10; A41D 11/00; B32B 5/02; A41B 2400/62; A41B 2300/32; B32B 2437/00; A41B 2300/324; B32B 2250/02; B32B 2307/7265; B32B 2250/03; A41B 2300/33

(57) ABSTRACT

A child garment includes a body portion having a bottom end and a top end, sleeves extending from an upper region of the body portion, a lip extending from the bottom end of the body portion, a neck portion at the top end of the body portion, the neck portion being configured to secure the garment around the neck of a child, and at least one fastener extending from the body portion, the at least one fastener being configured to secure the garment over a child car seat. At least the body portion comprises a liquid-resistant material layer. A travel kit includes at least one child garment and at least one strap and at least one resealable carrying bag. A method of protecting a child from soiling includes placing the child garment on the child while the child is seated in a child car seat.

### FIELD OF THE INVENTION

The present invention concerns to a child garment, and in particular a child garment for use with a child car seat, or other like child seating devices. The invention also concerns a travelling kit containing a child garment according to the present invention.

### BACKGROUND OF THE INVENTION

It is well appreciated that children (e.g., young children, including though not limited to ages 2-12; toddlers; babies; etc.) are prone to spillage from food, dribbling, and emesis; and that such events often result in soiling of the child and the child's clothes, and in some cases soiling of a car seat (or other like child seating device) in which the child may be secured at that time. If a child is prone to motion sickness, then such soiling may occur quite frequently when the child is secured in a car seat, thereby necessitating repeat cleansing of the child, the child's clothing and the car seat. Cleaning of the car seat in particular can prove especially difficult in instances where the buckles, straps, seat cushions, clasps and any other non-removable parts or accessories thereof are soiled; and even after the most thorough cleaning, an odor may still linger.

Past attempts to protect against such soiling have included the use of bibs, smocks and wearable blankets. However, such products conventionally provide only limited protection to the child and child's clothing; provide limited or no protection to a car seat or other seating device in which the child is seated; and/or undesirably restrict the child's freedom of movement.

Bibs, for example, commonly take the form of a small panel that secures around a child's neck to protect only a portion of the child's torso immediately below the neckline. As such, bibs do not provide a favorable degree of protection for the child or the child's clothing, and fail to provide any protection for a car seat or other seating device in which the child is seated. In addition, conventional bibs are generally considered unsuitable for use with a child car seat, as the manner in which the bib is secured to the child and made to rest against the child's chest can obstruct proper operation of the car seat's securement hardware (e.g., shoulder straps, lap straps, harnesses, etc.).

Smocks also commonly secure around a child's neck, and often conform to the child's body to protect a larger region than that protected by bibs. However, conventional smocks do not provide suitable protection to the child's arm regions; fail to provide any protection for a car seat or other seating device in which the child is seated; and are often uncomfortable for the child to wear for extended periods of time. Furthermore, as with bibs, smocks are generally considered unsuitable for use with a child car seat, as the manner in which they conform to the child's body can obstruct proper operation of the car seat's securement hardware.

Wearable blankets may protect a yet greater region than that protected by either bibs or smocks; however, conventional wearable blankets do not secure around the child's neck, and are instead configured to simply rest atop the child's body. As a result, wearable blankets often do not remain adequately fixed in position and thus do not reliably protect the child, the child's clothing, or the car seat or other seating device in which the child is seated from soiling. Furthermore, wearable blankets are limited in their use in that the blanket is placed to either fully cover the child, with the child's freedom of movement restricted; or to only partially cover the child, such as when folded along the child's torso to permit the child's arms to be exposed, in which case the child's arm regions are not protected from soiling.

Accordingly, there remains a need in the art for a child garment that is suitable for protecting a large region of a child's body and clothing from soiling; which is also suitable for use with child seat devices, and especially child car seats and booster seats; and which is capable of reliably remaining in place, while not restricting the child's freedom of movement.

### SUMMARY OF THE INVENTION

The present invention is directed to a child garment, a travel kit including a child garment, and a method of protecting a child from soiling. A child garment according to the present invention includes a body portion having a bottom end and a top end, sleeves extending from an upper region of the body portion, a lip extending from the bottom end of the body portion, a neck portion at the top end of the body portion, the neck portion being configured to secure the garment around the neck of a child, and at least one fastener extending from the body portion, the at least one fastener being configured to secure the garment over a child car seat. At least the body portion comprises a liquid-resistant material layer.

The body portion of the child garment includes an open backside having at least a first flap and a second flap, with the body portion being dimensioned to drape over the securement hardware of a child car seat to thereby cover both a child secured in the car seat and the securement hardware of the car seat. The garment includes a multi-layered material, the multi-layered material including at least an inner layer of fabric material and an outer layer of liquid-resistant material.

The lip of the garment is constructed to capture liquids and some solids that dribble, roll or otherwise fall along the outer surface of the body portion. The lip may include a member (e.g., a plastic, silicone, rubber or fabric member) shaped to form an upwardly open channel for capturing liquids and solids that fall along the outer surface of the garment, and may further include a fluid absorbing material.

The garment is also provided with a strap that includes at least one fastener for releasably engaging with the at least one fastener extending from the body portion, the strap being dimensioned for extending under or around a child car seat while the at least one fastener of the strap is engaged with the at least one fastener of the body portion in order to fix the garment in a position to cover a child that is secured in the child car seat. The garment may include at least two fasteners, and the strap may include at least two fasteners configured to releasably engage with the at least two fasteners of the garment. The fasteners of the garment may also be suitably configured for selectively engaging each of: the strap; a seat belt in a vehicle; and lateral sides of a child car seat. The fasteners of the garment may further be suitable configured to releasably engage one another for securing the garment around the child.

The garment may be provided as part of a child travelling kit, with the kit including one or more of the garment, as well as one or more removable straps. The removable straps include at least two fasteners for releasably engaging with fasteners extending from the body portion of the garment, and are dimensioned for extending under or around a child car seat while the at least two fasteners of the strap are engaged with the at least two fasteners of the garment portion in order to fix the garment in a position to cover a child that is secured in the child car seat. The kit further includes a resealable bag dimensioned to receive the one or more garments and the one or more straps therein.

A method of protecting a child from soiling includes placing the child in a car seat, engaging securement hardware of the car seat over the child to secure the child in the car seat, placing a garment on the child by inserting the child's arms into sleeves on the garment, placing a neck portion of the garment around the neck of the child, and draping the garment over the child and the securing hardware of the car seat, and fixing the garment in place via engagement of a fastener on the garment. With this method, the garment may be placed on the child and fixed in position after securing the child in the car seat by engagement of the securement hardware, without requiring disengagement of the securement hardware. When fixing the garment in place via engagement of the fastener on the garment, the fastener may be engaged to: a seat belt in the vehicle in which the car seat is received; a lateral side of the car seat; or a fastener on a strap that is positioned to extend under or around the car seat.

With the garment so secured over a child seated in a child car seat, when there occurs a spillage that soils the garment, the fastener may then be disengaged and the soiled garment removed from the child, without requiring disengagement of the securement hardware of the car seat. Following removal of the soiled garment, an unsoiled garment may be placed on the child by inserting the child's arms into sleeves on the unsoiled garment, placing a neck portion of the unsoiled garment around the neck of the child, draping the unsoiled garment over the child and the securing hardware of the car seat, and fixing the unsoiled garment in place via engagement of a fastener on the unsoiled garment. In this way, an unsoiled garment may be placed on the child and fixed in position without requiring disengagement of the securement hardware of the car seat.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 illustrates a front elevation view of one example of a garment according the invention; and

FIG. 2 illustrates a back elevation view of the garment of FIG. 1.

### DETAILED DESCRIPTION OF THE INVENTION

The following disclosure discusses the present invention with reference to the examples shown in the accompanying drawings, though does not limit the invention to those examples.

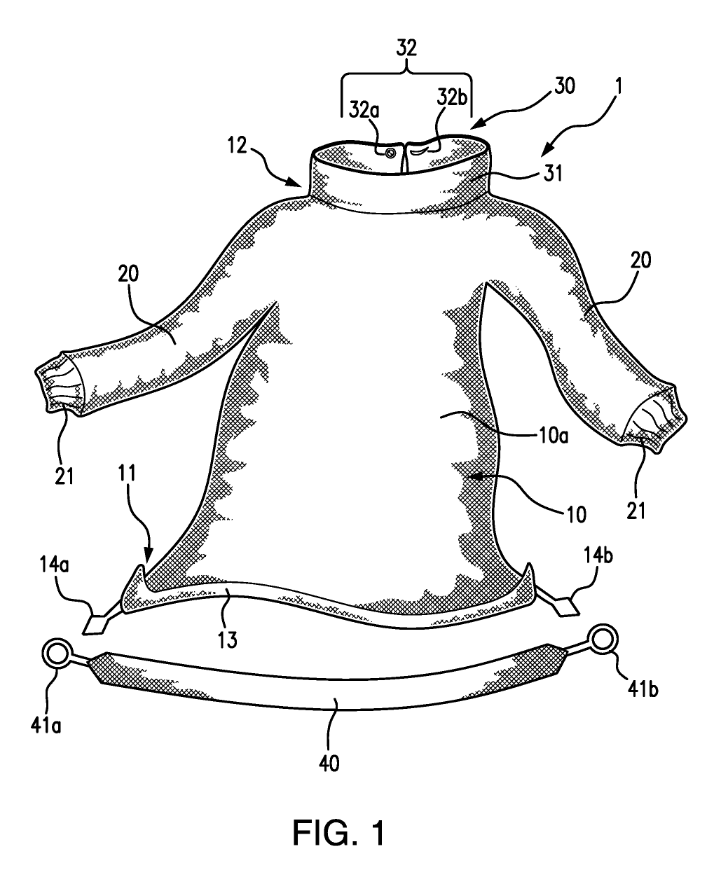

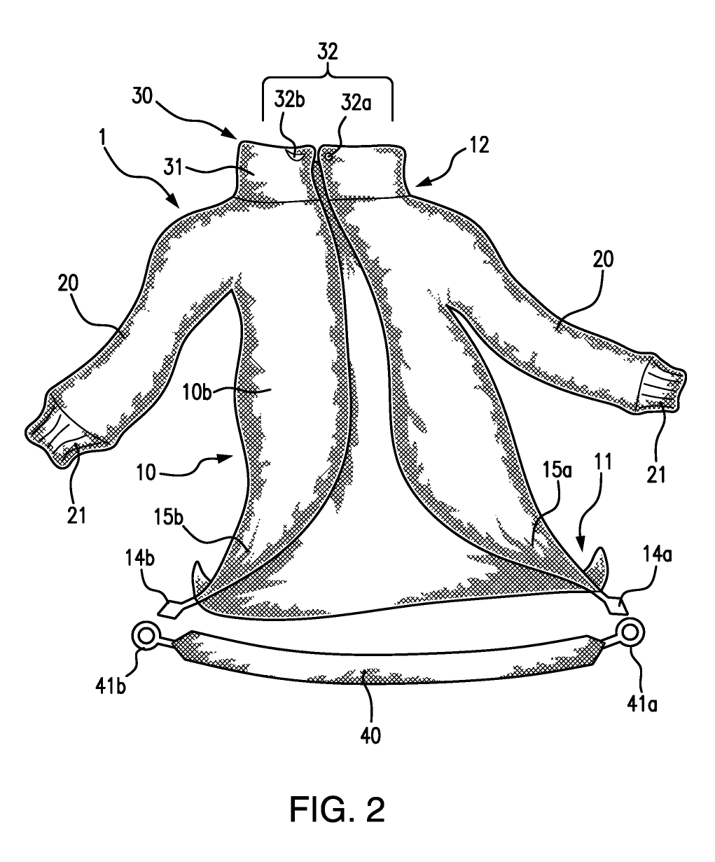

The present invention is inclusive of a child garment 1 having a body portion 10 having a bottom end 11 and a top end 12, and sleeves 20 that project from an upper region of the body portion 10. One example of a child garment according to the present invention is illustrated in FIGS. 1-2. A neck portion 30 at the top end 12 of the body portion 10 is configured to releasably secure the garment 1 around the neck of a child; and a lip 13 is provided at the bottom end 11 of the body portion 10 for catching fluid. At least one, and preferably two or more fasteners 14a/14b extend from the body portion 10 for mating with at least one, and preferably two or more fastener's 41a/41b on a strap 40; the strap 40 being dimensioned to extend under (or otherwise around) a child car seat 100 for securing the garment 1 over the car seat 100.

In the example shown in FIGS. 1-2, the body portion 10 includes a front side 10a and an open back side 10b, the open back side 10b having at least first and second flaps 15a/15b. The open back side 10b permits the garment 1 to be secured to a child that is already seated and secured in a car seat 100 by simply securing the garment 1 around the child's neck, without requiring removal of the child from the car seat 100 or disengagement of the car seat securement hardware 150. Advantageously, the open back side 10b enables securing the garment 1 to the child by placing the garment 1 over the securement hardware 150 of the car seat 100, such that the garment 1 not only avoids interfering with operation of the securement hardware 150 but also covers the securement hardware 150 to protect from soiling. The open back side 10b also permits at least a lower region of the first and second flaps 15a/15b to be draped over the lateral sides of the car seat 100.

In the example shown in FIGS. 1-2, the neck portion 30 includes a standing collar 31 that extends from the top end 12 of the body portion 10 so as to at least partially cover a child's neck. In other examples, the neck portion 30 may include a standard collar 31 (e.g., a crew neckline) that closely follow the top end 12 of the body portion 10, to extend along a child's collarbone. In yet other examples, the neck portion 30 may include a full-standing collar 31 (e.g., a mock turtleneck) that extends from the top end 12 of the body portion 10 so as to extend over the entire length of a child's neck. It will be appreciated that standing collars 31 (including full-standing collars) provide greater protection against soiling by restricting spillage from rolling down the child's chin and neck, and under the garment 1.

The neck portion 30 is configured to secure the garment 1 around the child's neck. This can be done in a number of ways. In the example shown in FIGS. 1-2, the neck portion 30 includes a clasp 32 comprising first and second mating units 32a/32b. Examples of suitable clasps include, though are not limited to: a button and mating buttonhole; mating snap-buttons; mating hook-and-loop materials (e.g., Velcro®); a magnetic clasp (e.g., with either one magnet and one ferrous metal, or with two magnets); a mating rod and ring clasp (e.g., one or more rods received through one or more rings); a mating snap-hook and ring. In other examples, the neck portion 30 may be made in a closed configuration, without use of a clasp, and the neck portion 30 may be made with an elastic characteristic to permit stretching of the neck portion 30 to secure the garment 1 to a child by simply pulling the neck portion 30 over the child's head.

Regardless of the configuration chosen, it is preferable the neck portion 30 be capable of securing the garment 1 to a child that is already seated and secured (e.g., buckled) in a child car seat 100, such that the garment 1 may be secured to the child without requiring removing the child from the car seat 100 or disengaging the securement hardware 150 of the car seat 100; and such that the garment 1 may easily be placed to cover not only the child (and the child's clothing) but also the securement hardware 150 of the car seat 100.

The sleeves 20 are configured to receive a child's arms for the purpose of protecting the child's arms (as well as any clothing along the child's arms) from soiling, and for the additional purpose of further securing the garment 1 in place. In this way, the sleeves 20 cooperate with the neck portion 30 to provide an at least three-point anchoring for securing the garment 1 to the child. The sleeves 20 may be made to any preferable length—including full length to extend to the child's wrists; three-quarter length to extend to the child's forearms; and short-length to extend to the child's biceps. As shown in FIGS. 1-2, in some examples the sleeves 20 may include cuffs 21 at the ends thereof, with the cuffs 21 either being elastic in nature or having a clasp (such as that at the neck portion 30) for securing the cuffs around the child's wrists in a manner that restricts spillage from rolling down the child's hands and arms, and under the garment 1. Cuffs 21 may be provided on the sleeves 20 regardless of sleeve length.

The lip 13 provided at the bottom end 11 of the body portion 10 acts to catch fluids and small solids (e.g., food crumbs, regurgitated food solids, etc.) due to spillage by the child. The lip 13 may take a number of forms. For example, the lip 13 may be a formed as trim that extends along the bottom end 11 of the body portion 10, the trim being made from one or more layers of fabric material, with the total thickness of the trim made to be greater than the thickness of the body portion 10 above the trim. In another example, the lip 13 may include (alone or in combination with multiple other layers) a curved or otherwise angled member that may be made of plastic, silicone, rubber and/or fabric that is shaped to extend upward so as to present a trough-like channel that extends along the bottom end 11 of the body portion 10. In some examples, the lip 13 may be made to include a fluid absorbing material for capturing and retaining fluids so as to lessen the likelihood of the spilled fluids from rolling off the garment 1. The lip 13 may include such a layer of fluid absorbing material regardless of the chosen form of the lip 13 e.g., trim, channel, etc.).

In the example shown in FIGS. 1-2, two fasteners 14a/14b are provided at the bottom end 11 of the body portion 10, at the outer edges of the first and second flaps 15a/15b. In other examples, the fasteners 14a/14b may be positioned at other locations on the garment 1. The fasteners 14a/14b are made to mate with fasteners 41a/41b provided on the strap 40. The strap 40 is dimensioned to extend under (or otherwise around) a child car seat 100 for securing the garment 1 over the car seat 100. The strap 40 may be made to have an elasticity that permits the strap 40 to stretch and contract to some degree to facilitate its use with car seats of various sizes and dimensions; and for use with children of varying ages and sizes. The strap 40 may also be made adjustable in size, for example by providing a sliding adjuster through which the strap 40 is looped, or a series of spaced holes with a frame and prong that is adjustable for separately engaging each of the spaced holes as desired.

Examples of suitable fasteners include, though are not limited to: a button and mating buttonhole; mating snap-buttons; mating hook-and-loop materials (e.g., Velcro®); a magnetic fastener (e.g., with either one magnet and one ferrous metal, or with two magnets); a mating rod and ring fastener (e.g., one or more rods received through one or more rings); a mating snap-hook and ring. Optionally, the fasteners may be a single fastening unit that is separate from the garment 1 itself. For example, a separate fastening unit may include two clamping fasteners (e.g., toothed clamping devices) that are joined to one another by a cord (e.g., an elastic strap), such that the separate fasteners of such a fastening unit are independently capable of clamping and releasing the first and second flaps 15a/15b.

In some examples, one of the fasteners 14a is a male fastener for mating with a female fastener 41a of the strap 40, and the other of the fasteners 14b is a female fastener for mating with a male fastener 41b of the strap 40. In this way, the strap 40 may selectively be fully removed from the garment 1, with the male fastener 14a and female fastener 14b instead made to mate with one another for securing the garment 1 around the child when the child is removed from the car seat 100.

In some examples, the garment 1 may include only a single one of the fasteners 14a/14b, and one end of the strap 40 may be permanently affixed to the body portion 10 of the garment 1 while a second end of the strap 40 is releasably engageable with the single fastener. In some examples, the fasteners 14a/14b may be made for mating, selectively, with any of: the fasteners 41a/41b on the strap 40; the belt straps of a vehicle; or with the lateral side edges of the car seat 100, such that the garment 1 may optionally be used with a car seat 100 without requiring use of the strap 40. The fastener's 14a/14b may be made so selectively engageable by constructing the clasps with a multi-purpose fastening structure, such as an enlarged snap-hook that is suitably dimensioned to permit clamping around a seat belt or over the lateral side of a car seat 100.

The garment 1 may be made of any material that provides adequate comfort and protection to the child. Preferably, the garment 1 is made of multiple layers that are inclusive of a soft fabric material layer and a liquid-resistant material layer, with the combined multiple layers presenting a combing light-weight multi-layer garment that can be comfortably worn by a child for extended periods of time. In two-layer examples, it is preferable the inner layer be a soft fabric material layer and the outer layer be a liquid-resistant layer, such that the garment 1 presents a comfortable and non-irritating feeling to the child. In a three-layer example, the it is preferable both the inner and outer layers of the multi-layered material be a soft fabric material layer, with the liquid-resistant layer positioned somewhere therebetween. Optionally, however, the garment 1 may be constructed with only a single layer; and that single layer may be either a soft fabric material layer or a liquid-resistant material layer.

The garment 1 may be made in a number of different sizes, such that an appropriate size may be chosen for use with children of different ages and sizes (e.g., young children, including though not limited to ages 2-12; toddlers; babies; etc.). The garment 1 may also be made in different lengths and dimensions—for example, the garment 1 may have a length that extends to the child's knees, or may have a length that extends beyond the child's feet.

The garment 1 may be provided as part of a kit, with the kit being inclusive of the garment 1, the strap 40, and a resealable carrying bag (e.g., via a zipper) that provides a fashionable and convenient way to carry the garment 1 and strap 40. Preferably, the carrying bag is made of a liquid-resistant and washable material, such that the carrying bag may be used to carry a soiled garment 1 in a manner to contain the spillage and any accompanying odor.

The kit may include multiple garments 1 according to the present invention, with the garments 1 being of the same or different sizes, length, and construction; and the kit may also include multiple straps 40 according to the present invention, with the straps 40 being of the same or different lengths and construction. A kit having multiple garments 1 of the same size, length and construction may be preferred for use with a child that frequently suffers from motion sickness, such that multiple garments 1 are available for use with the same child over a long travel period. A kit having multiple garments 1 of different size, length and/or construction may be preferred for use by a family having multiple children of different ages and sizes. A kit having multiple straps 40 of the same size an constructions may be preferable for providing a replacement strap 40 in the event of loss. A kit having multiple straps 40 of the different sizes an constructions may be preferable for rendering the garment 1 usable with different car seats of varying sizes and dimensions.

In a first method of use, wherein the garment 1 is used without the strap 40, a child is first placed into a car seat 100 and the securement hardware 150 of the car seat 100 is then engaged to secure the child safely in the car seat 100. Thereafter, the garment 1 is secured to the child by affixing the neck portion 30 around the child's neck. This can be done either by engaging a clasp 32 on an open neck portion 30, or by sliding a closed and elastic neck portion 30 over the child's head. The child's arms are also placed into the sleeves 20 of the garment 1, with the child's hands pulled through the ends of the sleeves 20. Once secured to the child, the garment 1 is then fanned out to cover the child, with the body portion 10 draped over the child's chest, stomach and lap (and possibly beyond the child's feet, depending on the length), and with at least the bottom regions of the first and second flaps 15a/15b draped over the lateral sides of the car seat 100. The one or more fasteners 14a/14b are then secured to either the seat belts of the car or the lateral side edges of the car seat 100. The child is now securely seated in the car seat 100 via the securement hardware 150 of the car seat 100, with the garment 1 anchored in position to protect the child, the child's clothing, and the car seat 100 from soiling, while allowing the child a comfortable freedom of movement, including the ability to grip and hold food, toys, and the like.

In a second method of use, wherein the garment 1 is used with the strap 40, the strap is positioned under (or otherwise around) the car seat 100. For example, the strap 40 may be positioned to extend under the car seat 100, or to extend around a rear side of the car seat 100. While it is possible to position the strap 40 after placing the child in the car seat 100, it will normally be preferable to position the strap 40 prior to placing the child in the car seat 100. This method otherwise proceeds the same as the first method, with the further exception that the fasteners 14a/14b of the garment 1 are secured to the fasteners 41a/41b of the strap 40.

In a third method of use, the garment 1 may be secured to the child at the neck portion 30 prior to placing the child in the car seat. In such a method, it will be necessary to adequately shift the positioning of the garment 1 to thereby permit proper positioning and engagement of the securement hardware 150 of the car seat 100; and to then reposition the garment 1 over the securement hardware 150 and place the child's arms into the sleeves 20 after engaging the securement hardware 150. This method otherwise proceeds the same as either the first method (without use of the strap 40) or the second method (with use of the strap 40). This method may be preferable if the child is wearing the garment 1 prior to entry into the vehicle.

In the event of spillage, the fluids and/or solids will fall onto the garment 1 instead of on the child, the child's clothing, or the surfaces and crevices of the car seat 100 or the car. In this way, the garment 1 completely protects not only the child and the child's clothing, but also the hard to clean and non-removable pieces of the car seat 100 such as the seat cushions, buckles, straps, hardware, as well as the child's clothing and arms.

The lip 13 at the bottom end 11 of the body portion 10 will capture any spillage that rolls or tumbles down the body portion 10, thereby prevent spread of the spillage and limiting soiling to the garment 1 alone. The liquid-resistant construction of the garment 1 also inhibits and/or prevents the passage of any fluid therethrough, so as to further protect the child, the child's clothing and the car seat 100 from becoming soiled by any liquid in the spillage. Once a spillage has occurred, the garment 1 is removed from the child. If the garment 1 is being used with a kit, then the soiled garment 1 may be placed into the resealable bag to contain the spillage and any accompanying odor; and, if available, a second unsoiled garment 1 may then be placed on the child.

Owing to the open back side 10b of the garment 1, and the positioning of the garment 1 over the securement hardware 150 of the car seat 100, a soiled garment 1 can be easily removed from the child without requiring removal of the child from the car seat or disengagement of the securement hardware 150 of the car seat 100. Similarly, an unsoiled garment 1 may replace the soiled garment 1, and be positioned over the child and the car seat 100, without requiring removal of the child from the car seat 100 or disengagement of the securement hardware 150 of the car seat 100. This is especially advantageous as it not only limits the jostling of the child, but also enables removal of and replacement of a soiled garment while the vehicle continues travelling while at the same time keeping the child safely secured in the car seat 100. As such, it is not necessary that the vehicle be removed from traffic and stopped before removing a soiled garment and positioning of an unsoiled garment.

With a garment according to the present invention it is possible to protect a child, the child's clothing, and the car seat (including the securement hardware) from soiling due to spillage from food, dribbling, and emesis—and to do so while not interfering with operation of securement hardware of the car seat and without restricting the child's freedom of movement. Especially advantageous is that the garment protects the securement hardware of the car seat (e.g., the straps, buckles, cushions, etc.) from soiling; thereby avoiding the need for any time consuming cleaning of the many crevices of these non-removable parts.

When constructed with a lip at the bottom end of the body portion, it is also possible for the garment to capture and retain spilled liquids and solids to thereby further prevent soiling of the car seat, as well as the car itself. Furthermore, by constructing the garment with a liquid-resistant layer, there is yet a further protection from liquids soaking through the garment and onto the child, the child's clothing or the car seat. Such a liquid-resistant material provides the further advantage of making the garment easily washable—for example, via a common clothing washing machine. Further yet, by providing the garment with fasteners for mating with an accompanying strap, the seat belts in a car, and/or the lateral sides of a car seat, there provided a further advantage in that the garment is easily anchored in a chosen position to achieve a desired degree of protection.

With a garment according to the present invention it is expected that spillages during traveling will be better contained, will result in less soiling, and will be more easily cleaned—thereby lessening the likelihood of any need to clean the child, change the child's clothing, or clean the car seat. As a result, there is a significant reduction in the burdens that result from the spillage itself, which in turn provides an increased sense of security and peace of mind that alleviates apprehension and anxiety in the child, the caregiver and any other occupants of the vehicle such that travelling becomes a much less stressful experience for all involved.

In addition, when used in a kit, the ability to contain the spillage and the odor within a resealable bag provides a further advantage in that it limits the exposure of the spillage to the occupants of the vehicle, thereby lessening the likelihood that other occupants might become nauseas therefrom.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass additional embodiments embracing various changes and modifications relative to the examples disclosed herein without departing from the scope of the invention as defined in the appended claims and equivalents thereto.

For example, though the examples discussed above are directed at use of the garment with a car seat, it will be understood that a garment according to the present invention is considered applicable to child seating devices generally, which may further include, though is not limited to: strollers, walkers, bouncing chairs, high chairs, booster chairs, and the like. In this regard, as concerning kits that are inclusive of the garment, it will be appreciate that the kits may include multiple garments and/or straps that are each differently dimensioned or otherwise adapted for use with a specific child seating device.

Also, while the disclosed methods of use may be performed by executing all of the disclosed steps in the precise order disclosed, without any intermediate steps therebetween, those skilled in the art will appreciate that the methods may also be performed: with further steps interposed between the disclosed steps; with the disclosed steps performed in an order other than the exact order disclosed; with one or more disclosed steps performed simultaneously; and with one or more disclosed steps omitted.

The present invention is not limited to the exemplary embodiments illustrated herein, but is instead characterized by the appended claims.

What is claimed is:

1. A child garment, comprising:
a body portion having a bottom end and a top end;
sleeves extending from an upper region of the body portion;
a lip extending from the bottom end of the body portion;
a neck portion at the top end of the body portion, the neck portion being configured to secure the garment around the neck of a child;
at least one fastener extending from the body portion, the at least one fastener being configured to secure the garment over a child car seat,
wherein at least the body portion comprises a liquid-resistant material layer.

2. The child garment according to claim 1, wherein the body portion comprises an open backside having at least a first flap and a second flap.

3. The child garment according to claim 1, wherein the body portion is configured to drape over the securement hardware of a child car seat to thereby cover both a child secured in the car seat and the securement hardware of the car seat.

4. The child garment according to claim 1, wherein the garment comprises a multi-layered material, the multi-layered material comprising an inner layer of fabric material and an outer layer of liquid-resistant material.

5. The child garment according to claim 1, wherein the lip comprises a member shaped to form an upwardly open channel for capturing liquids and solids that fall along the outer surface of the garment.

6. The child garment according to claim 1, wherein the lip comprises a fluid absorbing material.

7. The child garment according to claim 1, further comprising:
a strap comprising at least one fastener for releasably engaging with the at least one fastener extending from the body portion,
wherein the strap is dimensioned for extending under or around a child car seat while the at least one fastener of the strap is engaged with the at least one fastener of the body portion in order to fix the garment in a position to cover a child that is secured in the child car seat.

8. The child garment according to claim 7, wherein
the garment comprises at least two fasteners, and the strap comprises at least two fasteners configured to releasably engage with the at least two fasteners of the garment.

9. The child garment according to claim 7, wherein
the garment comprises at least two fasteners, the two fasteners being configured for selectively engaging each of: the strap; a seat belt in a vehicle; and lateral sides of a child car seat.

10. The child garment according to claim 1, wherein
the garment comprises at least two fasteners, the at least two fasteners being configured to releasably engage one another for securing the garment around the child.

11. A child travelling kit, comprising:
at least one garment according to claim 1; and
a resealable bag dimensioned to receive the at least one garment therein.

12. The child travelling kit according to claim 11, wherein
the at least one garment comprises at least two fasteners extending from the body portion,
the kit further comprises at least one removable strap, the removable strap comprising at least two fasteners for releasably engaging with the at least two fasteners extending from the body portion of the garment,
the removable strap is dimensioned for extending under or around a child car seat while the at least two fasteners of the strap are engaged with the at least two fasteners of the garment portion in order to fix the garment in a position to cover a child that is secured in the child car seat, and
the resealable bag is dimensioned to simultaneously receive the at least one strap and the at least one garment therein.

13. A method of protecting a child from soiling, comprising:
placing the child in a car seat;
engaging securement hardware of the car seat over the child to secure the child in the car seat;
placing a garment on the child by inserting the child's arms into sleeves on the garment, placing a neck portion of the garment around the neck of the child, and draping the garment over the child and the securing hardware of the car seat; and
fixing the garment in place via engagement of a fastener on the garment,
wherein the garment is placed on the child and fixed in position after securing the child in the car seat by engagement of the securement hardware, without requiring disengagement of the securement hardware.

14. The method of claim 13, wherein
fixing the garment in place via engagement of the fastener on the garment comprises engaging the fastener on the garment to a seat belt in the vehicle in which the car seat is received.

15. The method of claim 13, wherein
fixing the garment in place via engagement of the fastener on the garment comprises engaging the fastener on the garment to a lateral side of the car seat.

16. The method of claim 13, further comprising:
positioning a strap to extend under or around the car seat,
wherein fixing the garment in place via engagement of the fastener on the garment comprises engaging the fastener on the garment to a fastener on the strap.

17. The method of claim 13, further comprising:
following a spillage that soils the garment, disengaging the fastener of the soiled garment and removing the soiled garment from the child without requiring disengagement of the securement hardware of the car seat.

18. The method of claim 17, further comprising:
following removal of the soiled garment, placing an unsoiled garment on the child by inserting the child's arms into sleeves on the unsoiled garment, placing a neck portion of the unsoiled garment around the neck of the child, draping the unsoiled garment over the child and the securing hardware of the car seat, and fixing the unsoiled garment in place via engagement of a fastener on the unsoiled garment,
wherein the unsoiled garment is placed on the child and fixed in position without requiring disengagement of the securement hardware of the car seat.
